(19) United States
(12) Patent Application Publication
(10) Pub. No.: US 2010/0119281 A1
(43) Pub. Date: May 13, 2010

(54) Cartridge Media Retention Mechanism

(76) Inventors: Thomas D. R. Ford, Royston (GB); Anthony R. Dunn, Whittlesford (GB)

Correspondence Address: QUARLES & BRADY LLP, 411 E. WISCONSIN AVENUE, SUITE 2040, MILWAUKEE, WI, 53202-4497, US

(21) Appl. No.: 12/613,587

(22) Filed: Nov. 6, 2009

Related U.S. Application Data
(60) Provisional application No. 61/113,124, filed on Nov. 10, 2008.

(51) Int. Cl. B41J 11/48

(52) U.S. Cl. 400/586

(57) ABSTRACT

A media cartridge is disclosed for use in a printer that prints onto the media. The media cartridge includes a cartridge housing having an exit passage. The media cartridge has a length of media with an end extending from the exit passage. The media cartridge further includes a retaining arm having a pinch position and an open position. In the pinch position, the retaining arm impinges on the media in the exit passage to inhibit passage of the media through the exit passage. In the open position, the retaining arm allows passage of the media through the exit passage.

### CROSS-REFERENCE TO RELATED APPLICATION

This application claims the benefit of U.S. Provisional Patent Application No. 61/113,124 filed Nov. 10, 2008, the disclosure of which is hereby incorporated by reference in entirety.

### STATEMENT OF FEDERALLY SPONSORED RESEARCH OR DEVELOPMENT

Not applicable.

### BACKGROUND OF THE INVENTION

This invention relates to cartridges for printers. In particular, this invention relates to retention mechanisms for preventing the undesired movement of media within the cartridge when the cartridge is not loaded in the printer.

Handheld printers are used for printing applications in which portability and mobility are important considerations. Many such handheld printers are designed to receive cartridges containing rolls of media. This media may be, for example, adhesive-backed labels for application to documents, packages, and the like.

Providing the media in cartridge form provides many benefits. One benefit is that the media can be protected inside of a cartridge housing. This reduces the risk of the media being damaged if the printer is mishandled or operated in a harsh environment. Another benefit is that the structure of the cartridge may improve the loading of the media into the printer. Typically, it is difficult for a user to manually thread the media between the print head and a platen roller, given the small size of most handheld printers and the tight confines into which the media would need to be loaded. The cartridge can be designed so that, during the loading of the cartridge into the printer, the media is automatically placed between the print head and platen roller.

However, storing the media in a cartridge also creates problems. Typically, the media in cartridges is coiled into a roll and a free end of the media extends from an exit end of the cartridge. If the free end is pulled into the cartridge, then it is usually inaccessible and the cartridge is rendered useless. Even if the free end remains outside the cartridge, it is possible that the media could be pulled out of any media guides that guide the free end of the media. If the free end is not guided properly past the print head and platen, then improper loading or feeding the media could jam the printer.

One solution to this problem has been to include a disposable adhesive transportation tab on the cartridge. This tab prevents the media in the cartridge from feeding forwards or backwards until the cartridge has been loaded in the printer and the tab has been removed. However, once the tab is removed, the cartridge must remain in the printer to maintain tension on the media. Hence, this solution does not accommodate the transfer of cartridges between printers or the switching of cartridges within a printer to change the type of media being printed on.

Another solution to this problem has been to provide a long path for the media within the cartridge to frictionally prevent the media from recoiling. However, having a long path increases the footprint of the cartridge and increases the force required to feed the media. This presents inefficiencies in feeding and marginalizes some of the benefit of reducing the size of the printer in the first instance.

Hence, a need exists for an improved way of preventing the movement of the free end of a length of media extending from a cartridge when the cartridge is not load in a printer.

### SUMMARY OF THE INVENTION

A media cartridge is disclosed for use in a printer that prints onto the media. The media cartridge includes a cartridge housing having an exit passage. The media cartridge has a length of media with an end extending from the exit passage. The media cartridge further includes a retaining arm having a pinch position and an open position. In the pinch position, the retaining arm impinges on the media in the exit passage to inhibit passage of the media through the exit passage. In the open position, the retaining arm allows passage of the media through the exit passage.

According to one form of the media cartridge, a protrusion may extend outwardly from the cartridge housing. The protrusion may be engageable with an engagement structure on the printer to move the retaining arm from the pinch position to the open position when the media cartridge is loaded into the printer. The protrusion may be integrally formed with the retaining arm. The retaining arm may be separately formed from the cartridge housing.

According to another form of the media cartridge, when in the pinch position, the retaining arm and a portion of the cartridge housing may both contact the media.

According to yet another form of the media cartridge, when in the pinch position, the retaining arm may contact the media to convolute a path of the media.

A cartridge is also disclosed that has a media retention mechanism for use in a printer adapted to removably receive the cartridge. A cartridge housing contains a length of media. At least a portion of the length of media extends from an exit passage of the cartridge housing. A biasing mechanism biases a retaining arm part towards a portion of the cartridge housing. The media extends between the retaining arm part and the portion of the cartridge housing.

According to one aspect of the cartridge, the retaining arm part may have a pinch position in which the retaining arm part is driven toward the portion of the cartridge housing by the biasing mechanism to contact the media and an open position in which the retaining arm part is moved away from the portion of the cartridge housing to release the media. When the cartridge is inserted into the printer adapted to receive the cartridge, the protrusion on the retaining arm part may be actuated by the printer to move the retaining arm part to the open position. In the pinch position, the media may be pinched between the retaining arm part and the portion of the cartridge housing. In the pinch position, the media may be frictionally held in place by the retaining arm part and the portion of the cartridge. In the pinch position, the retaining arm part may contact the media to form a convoluted guide path for the media.

According to another aspect of the cartridge, the biasing mechanism may be a spring.

According to yet another aspect of the cartridge, the retaining arm part may be formed separately from the cartridge housing. The retaining arm part may be at least partially outside the cartridge housing.

According to one aspect of the cartridge, the cartridge may be for a thermal transfer printer.

According another aspect of the cartridge, the cartridge housing may comprise at least two case parts.

According to yet another aspect of the cartridge, the retaining arm part may be rotatable about an axis of rotation and the biasing mechanism may rotatably bias the retaining arm part towards a portion of the cartridge housing.

According to still another aspect of the cartridge, the cartridge includes media guides for guiding the length of media extending from the exit passage.

Thus, the disclosed media cartridge and associated retention mechanism provide an improved way of inhibiting the movement of a free end of a length of media when the cartridge is not loaded in a printer. Prior to the insertion of the cartridge in the printer or when the cartridge is removed from the printer, the retention mechanism inhibits the movement of the media. However, when the cartridge is inserted into the printer, the retention mechanism allows the media to be fed. With this design, the free end of the length of media is unlikely to recoil into the cartridge housing, rendering the cartridge unusable. Moreover, the retention mechanism helps to keep the end of the length of media in the media guides, so that during insertion of the cartridge into the printer, the media is properly threaded between the print head and the platen roller. This minimizes the risk of the media jamming during printing or feeding.

These and still other advantages of the invention will be apparent from the detailed description and drawings. What follows is merely a description of the preferred embodiments of the present invention. To assess the full scope of the invention, the claims should be looked to as the preferred embodiments are not intended to be the only embodiments within the scope of the claims.

### BRIEF DESCRIPTION OF THE DRAWINGS

FIG. 1 is a perspective view of a handheld printer with a cartridge placed therein;

FIG. 2 is an exploded perspective view of the handheld printer of FIG. 1 in which the cartridge is removed from the printer;

FIG. 3 is an exploded view of the cartridge;

FIG. 4 is a cross-sectional view of the cartridge with the retaining arm in the pinch position taken along line 4-4 of FIG. 2;

FIG. 5 is a cross-sectional view of the cartridge in the printer in which the retaining arm has been moved to the open position by an engagement surface of the printer taken along line 5-5 of FIG. 1;

FIG. 5A is a detailed cross-sectional view of the interaction between the protrusion an the printer taken along line 5A-5A of FIG. 5;

FIG. 6 is a perspective view of the cartridge with the top housing removed to reveal and better show the exit passage of the cartridge; and

FIG. 7 is a perspective view of another embodiment of the cartridge in which the biasing mechanism is a spring in tension.

### DETAILED DESCRIPTION OF THE PREFERRED EMBODIMENTS

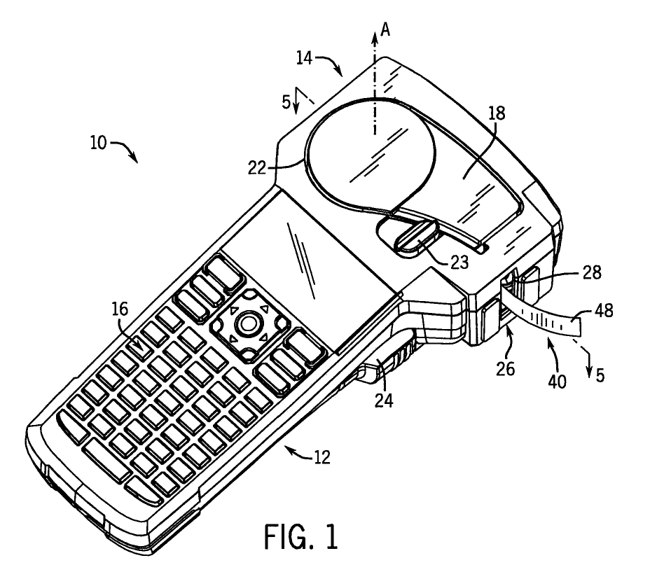

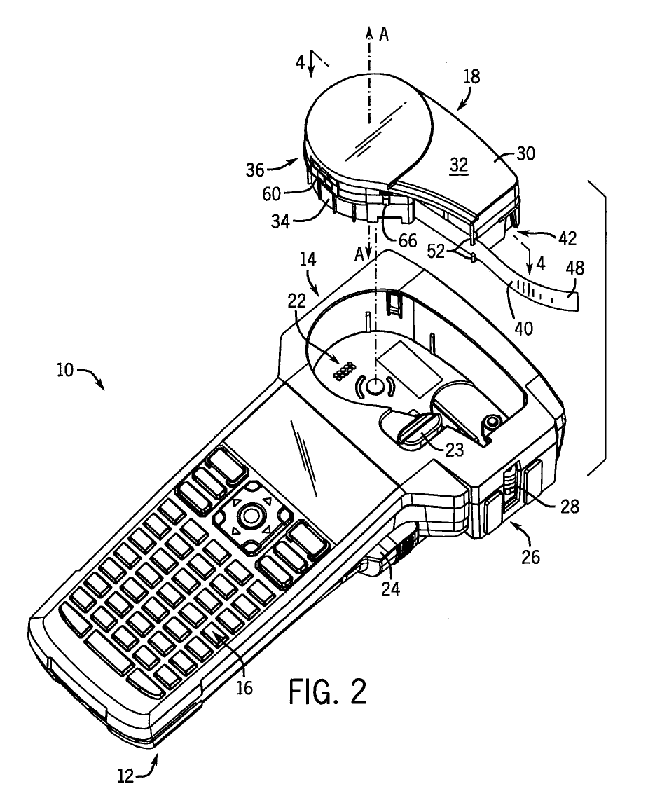

Referring first to FIGS. 1 and 2, a handheld printer 10 is shown. The handheld printer 10 has a body portion 12 and a head portion 14. The body portion 12 includes a keypad 16 for entering data and operating the handheld printer 10. On the lateral sides of the body portion 12 of the handheld printer 10 there are a pair of buttons 24. Preferably, the pair of buttons 24 are located on opposing sides of the handheld printer 10 such that the pair of buttons 24 can be actuated towards the body portion 12 and, at the same time, towards one another (by a pinching motion).

The head portion 14 is adapted to receive a cartridge 18. The cartridge 18 is removably received into a bay 22 in the head portion 14 of the handheld printer 10. A rotating lock 23 on the handheld printer 10 is used to retain the cartridge 18 within the bay 22.

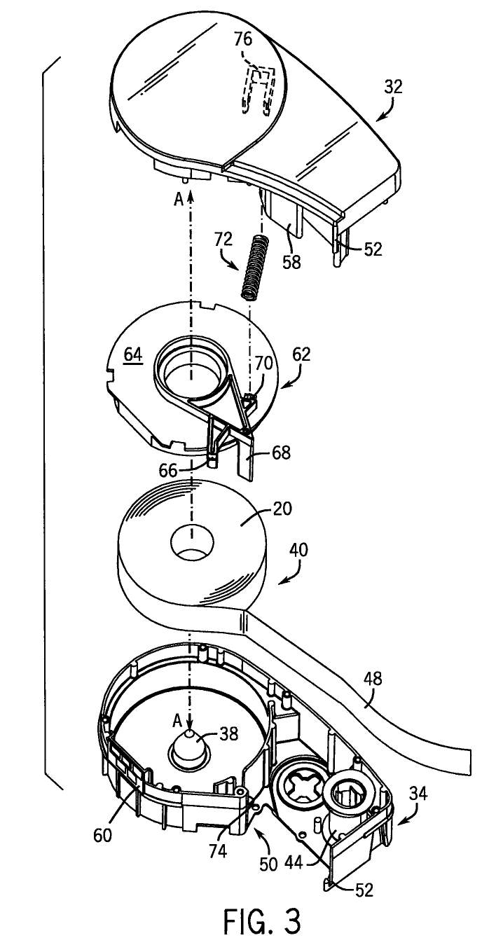

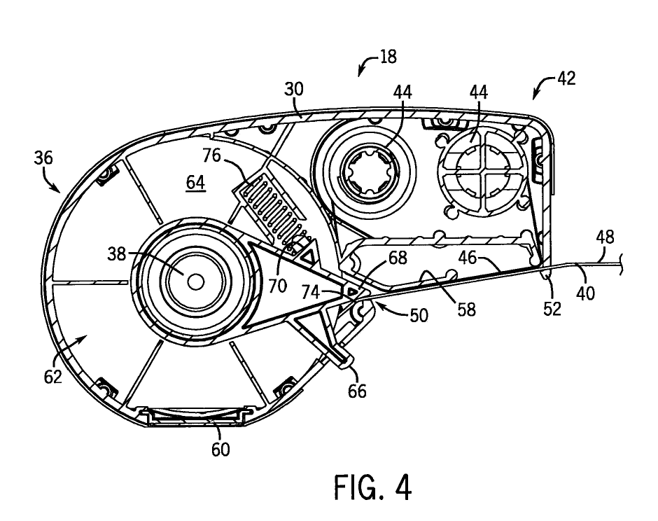

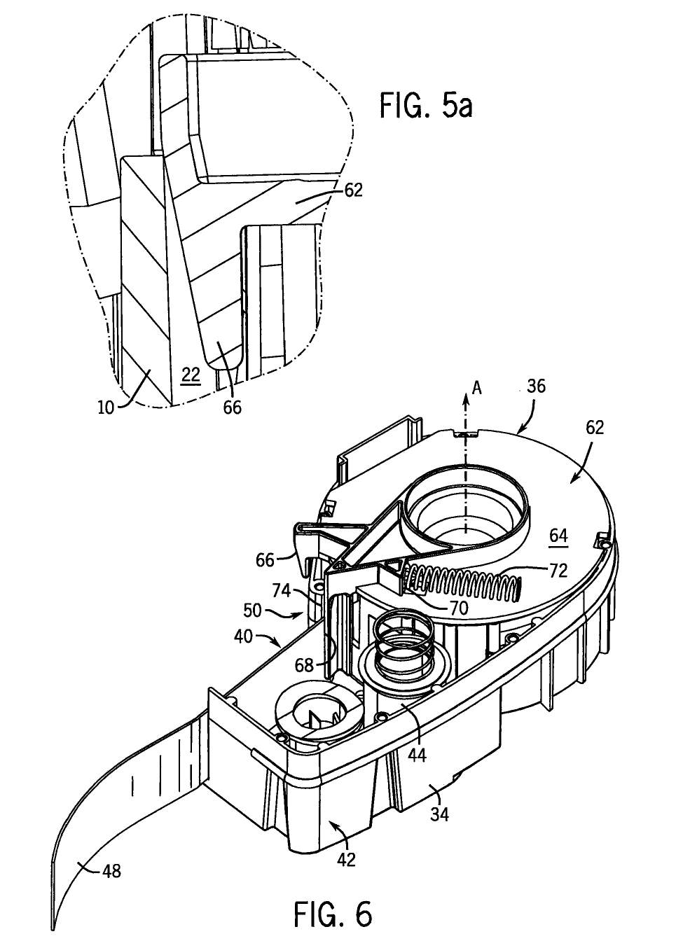

Referring now to FIGS. 3-6, the various parts of the cartridge 18 can be seen. As best seen in FIG. 3, the cartridge 18 houses a roll 20 of printing media 40 such as, for example, adhesive-backed labels. The cartridge 18 further includes a cartridge housing 30 comprising a top housing 32 and a bottom housing 34 that are joined together. However, in other forms, the cartridge housing 30 may be a single piece or may include more than two pieces. The cartridge housing 30 supports the roll 20 and the various other internal parts of the cartridge 18 as will be described below.

In general, the cartridge 18 has two sides as viewed from the front of the handheld printer 10 when the cartridge 18 is loaded into the bay 22. On a left side portion 36, a spool 38 formed in the bottom housing 34 supports the roll 20 of printing media 40. On a right side portion 42, there are two spools 44 with an ink ribbon 46 spanning therebetween. The printing media 40 is wrapped about the spool 38 and a free end 48 of the printing media 40 extends from the roll 20 towards the right side portion 42 of the cartridge 18. The free end 48 extends though an exit passage 50 located between the left side portion 36 and the right side portion 42.

After passing through the exit passage 50, the free end 48 then extends through media guides 52 on the far right side of the cartridge 18. For a distance between the exit passage 50 and the media guides 52, the free end 48 of the roll 20 and the ink ribbon 46 run substantially parallel to one another.

A guide tab 58 formed on the cartridge 18 extends for a portion of the length between the exit passage 50 and the media guides 52 prior to the thermal print head 54. The guide tab 58 helps to define the path of the ink ribbon 46 as it passes between the two spools 44 and also guides the printing media 40 between the exit passage 50 and the media guides 52.

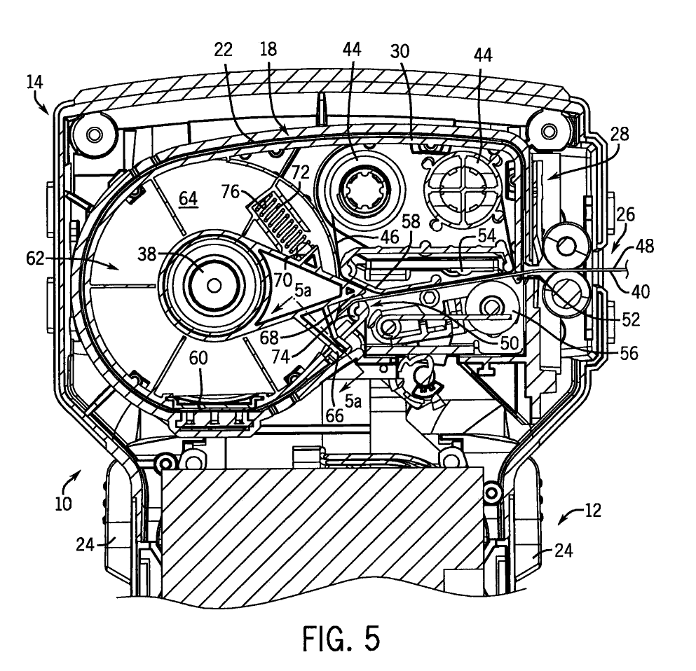

As best seen in FIG. 5, when the cartridge 18 is received in the handheld printer 10, a portion of the free end 48 of the printing media 40 and the ink ribbon 46 are threaded between a thermal print head 54 and a platen roller 56 as the printing media 40 extends from the exit passage 50 to the media guides 52. In a gap between the end of the guide tab 58 and the media guides 52, there is sufficient room for placement of the thermal print head 54 for printing on the printing media 40.

The bottom of the cartridge 18 may also include an identification plate 60. The identification plate 60 may have conductive surfaces which selectively provide electrical pathways to contacts in the bay 22 of the handheld printer 10. Depending on the electrical connectivity of the contacts resulting from the electrical pathways formed by the identification plate 60, different characterizing features of the cartridge 18 may be indicated to the handheld printer 10 (e.g., the type of media, the length of media, the type of ink, the compatibility of the cartridge with the printer, and so on).

Most notably, however, the cartridge 18 includes a retaining arm 62. In the form shown, the retaining arm 62 includes a hub 64 that is rotatable about an axis of rotation A-A coaxial with the roll 20. The hub 64 includes a protrusion 66 that extends outwardly from the cartridge housing 30, a pinch finger 68, and hub biasing surface 70 for engaging a biasing mechanism which is, in the form shown, a compression spring 72.

The pinch finger 68 extends axially downward from a periphery of the hub 64 such that the pinch finger 68 forms a portion of the exit passage 50 along with a portion of the cartridge housing 30. In the embodiment shown, the exit passage 50 for the printing media 40 is defined on one side by the pinch finger 68 and, on the other side, by an edge 74 of the bottom housing 34.

The retaining arm 62 is biased toward a pinch position by the biasing mechanism (the spring 72). In the form shown, the spring 72 is compressed between the hub biasing surface 70 of the retaining arm 62 and a house biasing surface 76 of the top housing 32. As the spring 72 attempts to expand, it drives the hub biasing surface 70 away from the housing biasing surface 76. This, in turn, imposes a clockwise torque on the retaining arm 62 (as viewed from the front of the cartridge 18). This applied torque causes the pinch finger 68 of the retaining arm 62 to be driven toward the edge 74 of the bottom housing 34 thus “pinching” or impinging on the printing media 40 extending through the exit passage 50 between the cartridge housing 30 and the retaining arm 62.

In the pinch position, the retaining arm 62 inhibits the passage of the printing media 40 through the exit passage 50. The pinching frictionally captures the printing media 40 to inhibit the backwards feeding of the printing media 40 due to an uncoiling of the roll 20.

Referring now to FIG. 5, during the loading of the cartridge 18 into the bay 22 of the handheld printer 10, the protrusion 66 outside of the cartridge housing 30 engages a wall or other engagement structure of the handheld printer 10. This engagement causes the rotation of the retaining arm 62 and the release of the free end 48 of the printing media 40.

Preferably, As can be best seen in FIG. 5A, the protrusion 66 has a tapered profile such that, during loading into handheld printer 10, the protrusion 66 interferes a wall of the bay 22. The tapered profile of the protrusion 66 causes the protrusion 66 to rotate as the protrusion 66 is wedged into the bay 22.

The induced rotation of the retaining arm 62 during loading causes the retaining arm 62 to move to an open position. In the open position, the pinch finger 68 moves away or is separated from the edge 74 of the bottom housing 34. This allows the printing media 40 to move through the exit passage 50 of the cartridge 18. In this state, the printing media 40 may be pulled from the roll 20, printed on, and fed through the discharge slot 26 of the handheld printer 10.

After the printing media 40 has been fed through the discharge slot 26, the pair of buttons 24 may be pressed to operate a cutting mechanism 28. The cutting mechanism 28 cuts the printing media 40 to separate the portion of the printing media 40 extending from the discharge slot 26 of the handheld printer 10 from the rest of the roll 20.

Thus, the cartridge 18 has a retention mechanism that selectively allows or inhibits the feeding of the printing media 40. Whether or not feeding can occur is conditioned on whether the cartridge 18 is loaded into the handheld printer 10.

When the cartridge 18 is not loaded in the handheld printer 10, the retention mechanism is biased such that the feeding of printing media 40 is inhibited. This may be the case, for example, before the cartridge is put into use or after removing a partially used cartridge to put in another type of printing media.

Although the retaining arm 62 is shown pinching the printing media 40, the retaining arm 62 could inhibit the movement of the printing media 40 in some other way. For example, the retaining arm 62 may convolute the guide path of the printing media 40 to make feeding more difficult.

Although the retaining arm has been shown as being formed separately from the cartridge housing, the retaining arm could also be integrally formed with at least a portion of the cartridge housing. In some forms, the biasing mechanism may be integrally formed with at least a part of the cartridge housing. If this is the case, the biasing mechanism could move from the pinch to open positions via elastic deformation.

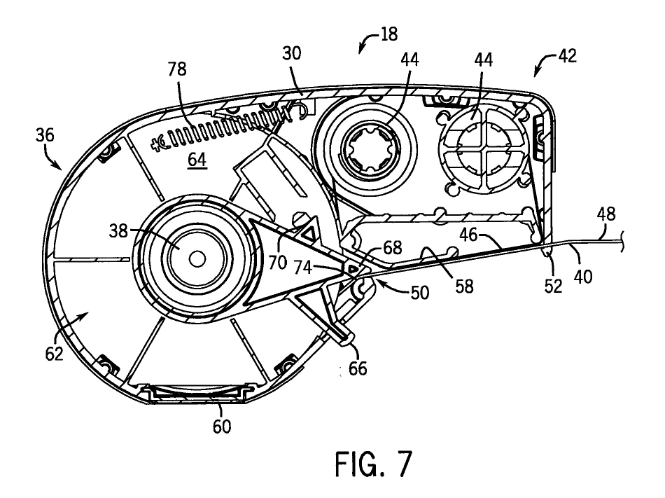

Moreover, although the biasing mechanism has been shown as a compression spring, the biasing mechanism may take another form. For example, referring to FIG. 7, a tension spring 78, is used to cause the retaining arm 62 to rotate toward the pinch position.

Further, although the retaining arm is shown as a rotatable hub having the projection and pinch finger, other forms of retaining arms are contemplated. For example, rather than rotation, the portion of the retaining arm that pinches or impinges upon the printing media may be actuated in a linear direction. Moreover, the retaining arm may be an assembly of various components instead of an integrally formed component.

Although the protrusion has been shown as having a tapered profile that interacts with the wall of the bay to move the cartridge from the pinch position to the open position during loading, other constructions and types of interactions between these components are contemplated. For example, the protrusion may have essentially vertical surfaces that interact with a ramped surface on the bay wall to move the protrusion, and thus the retaining arm, during loading.

While a roll of printing media 40 has been described above, the length of media could take of number of forms. For instance, the media could be folded back and forth over itself with the folds at lines of perforation. Regardless of the form of the supply of the media within the cartridge 18, at least a portion of the length of media should extend though the exit passage 50 of the cartridge housing 30 for printing.

Many modifications and variations to these preferred embodiments will be apparent to those skilled in the art, which will be within the spirit and scope of the invention. Therefore, the invention should not be limited to the described embodiments. To ascertain the full scope of the invention, the following claims should be referenced.

### INDUSTRIAL APPLICABILITY

The invention provides a cartridge with a retention mechanism for avoiding the reverse feeding of printing media when the cartridge is not loaded in a printer.

What is claimed is:

1. A media cartridge for use in a printer that prints onto the media, the media cartridge comprising:
a cartridge housing having an exit passage;
a length of media having one end extending from the exit passage; and
a retaining arm having a pinch position and an open position wherein, in the pinch position, the retaining arm impinges on the media in the exit passage to inhibit passage of the media through the exit passage and wherein, in the open position, the retaining arm allows passage of the media through the exit passage.

2. The media cartridge as in claim 1, wherein a protrusion extends outwardly from the cartridge housing and is engageable with an engagement structure on the printer to move the retaining arm from the pinch position to the open position when the media cartridge is loaded into the printer.

3. The media cartridge as in claim 2, wherein the protrusion is integrally formed with the retaining arm.

4. The media cartridge as in claim 3, wherein the retaining arm is separately formed from the cartridge housing.

5. The media cartridge as in claim 1, wherein in the pinch position the retaining arm and a portion of the cartridge housing both contact the media.

6. The media cartridge as in claim 1, wherein in the pinch position the retaining arm contacts the media to convolute a path of the media.

7. A cartridge having a media retention mechanism for use in a printer adapted to removably receive the cartridge, the cartridge comprising:
a cartridge housing containing a length of media, at least a portion of the length of media extending from an exit passage of the cartridge housing;
a retaining arm part having a protrusion that extends outside of the cartridge housing; and
a biasing mechanism biasing the retaining arm part towards a portion of the cartridge housing, the media extending between the retaining arm part and the portion of the cartridge housing.

8. The cartridge as in claim 7, wherein the retaining arm part has a pinch position in which the retaining arm part is driven toward the portion of the cartridge housing by the biasing mechanism to contact the media and an open position in which the retaining arm part is moved away from the portion of the cartridge housing to release the media.

9. The cartridge as in claim 8, wherein, when the cartridge is inserted into the printer adapted to receive the cartridge, the protrusion on the retaining arm part is actuated by the printer to move the retaining arm part to the open position.

10. The cartridge as in claim 8, wherein, in the pinch position, the media is pinched between the retaining arm part and the portion of the cartridge housing.

11. The cartridge as in claim 10, wherein, in the pinch position, the media is frictionally held in place by the retaining arm part and the portion of the cartridge.

12. The cartridge as in claim 8, wherein, in the pinch position, the retaining arm part contacts the media to form a convoluted guide path for the media.

13. The cartridge as in claim 7, wherein the biasing mechanism is a spring.

14. The cartridge as in claim 7, wherein the retaining arm part is formed separately from the cartridge housing.

15. The cartridge as in claim 14, wherein the retaining arm part is at least partially outside the cartridge housing.

16. The cartridge as in claim 7, wherein the cartridge is for a thermal transfer printer.

17. The cartridge as in claim 7, wherein the cartridge housing comprises at least two case parts.

18. The cartridge as in claim 7, wherein the retaining arm part is rotatable about an axis of rotation and the biasing mechanism rotatably biases the retaining arm part towards a portion of the cartridge housing.

19. The cartridge as in claim 7, wherein the cartridge further comprises media guides for guiding the length of media extending from the exit passage.
